(19) United States
(12) Patent Application Publication
(10) Pub. No.: US 2026/0180491 A1
(43) Pub. Date: Jun. 25, 2026

(54) Hidden End Clamp for PV Panel Installation

(71) Applicant: Top Rack Technology, Inc,, Morrestown, NJ (US)

(72) Inventor: Guohao Zhu, Haining City (CN)

(73) Assignee: Top Rack Technology, Inc., Morrestown, NJ (US)

(21) Appl. No.: 19/175,662

(22) Filed: Apr. 10, 2025

(30) Foreign Application Priority Data
Dec. 19, 2024 (CN) 202423133898.8

(51) Int. Cl. H02S 20/00; H02S 40/30

(52) U.S. Cl. CPC H02S 20/00; H02S 40/30

(57) ABSTRACT

The present disclosure relates to a hidden end clamp for PV panel installation, comprising a fixed section, a movable section, and a tension wire. The This utility model has a simple structure, allows for easy installation, and remains concealed within the rail system, ensuring a clean and aesthetically pleasing appearance. The curved protrusion guides the bolt into position during tightening, while the semi-circular pull hook enhances installation convenience and user-friendliness.

### TECHNICAL FIELD

The present utility model relates to the field of solar photovoltaic (PV) technology, specifically to a hidden end clamp for PV panel installation.

### BACKGROUND TECHNOLOGY

A hidden end clamp for PV panel installation is typically used for securing the outermost PV panels in a mounting structure. End clamps play a critical role in meeting wind resistance, tensile strength, and deformation resistance requirements.

In conventional systems:
End clamps are generally installed on the outer edge of the rail.
They are fixed using bolts, which are separate components, making installation time-consuming and complex.
Since traditional end clamps are externally visible, they can negatively impact the overall aesthetics of the PV system.

### SUMMARY OF THE UTILITY MODEL

To address the limitations of existing technology, the present utility model provides a hidden end clamp for PV panel installation with a simple structure, enabling quick and convenient installation while remaining concealed within the rail, ensuring a clean and aesthetically pleasing appearance.

### Technical Solution

To achieve the above objectives, the present utility model provides a hidden end clamp for PV panel installation, comprising:
A fixed section
A movable section
A tension wire

### Structural Features

The fixed section includes:
   An upper spherical connection slot.
   A lower rail connection section, allowing for secure attachment within the mounting rail.
The movable section consists of:
   A frame pressing plate.
   A spherical protrusion, which movably connects to the spherical connection slot of the fixed section.
   The fixed and movable sections are secured using a bolt.
The tension wire features a pull ring, which loops around the bolt to secure the connection.

### Further Improvements

### 1. Guided Bolt Locking

A curved protrusion is added at the bolt connection point in the movable section, ensuring smooth guidance when tightening the bolt.

### 2. Ergonomic Installation Design

The tension wire is made of soft plastic, and its pull end features a semi-circular hook designed for easy handling and operation.

### 3. Integrated Grounding Mechanism

The frame pressing plate is equipped with a grounding pin, which is installed using an embedded connection method, ensuring electrical continuity.

### Advantages of the Utility Model

Fast installation using a combination of fixed, movable, and tension wire components.
Simple structure, reducing assembly time and complexity.
Concealed within the rail, ensuring a clean and visually appealing PV mounting system.
Curved protrusion facilitates accurate bolt alignment during installation, improving precision and reliability.
Soft plastic tension wire can be fully hidden within the rail after installation, maintaining a neat appearance.
Semi-circular pull hook allows for ergonomic and effortless installation.
   This hidden end clamp design is an effective and reliable solution for modern PV mounting systems, ensuring structural integrity, fast installation, and enhanced aesthetics.

### DESCRIPTION OF DRAWINGS

FIG. 1: Structural schematic diagram of the embodiment of the present utility model.

FIG. 2: Structural schematic diagram of the fixed section in the embodiment of the present utility model.

FIG. 3: Structural schematic diagram of the movable section in the embodiment of the present utility model.

FIG. 4: First installation schematic diagram of the embodiment of the present utility model.

FIG. 5: Second installation schematic diagram of the embodiment of the present utility model.

FIG. 6: Third installation schematic diagram of the embodiment of the present utility model.

FIG. 7: Fourth installation schematic diagram of the embodiment of the present utility model.

These figures visually illustrate the components, assembly process, and installation method of the hidden end clamp for PV panel installation, ensuring clarity and accuracy in the documentation of the present utility model.

### ILLUSTRATION LABELS IN THE DRAWINGS

29—Fixed Section
30—Movable Section
31—Tension Wire
32—Bolt
33—Spherical Connection Slot
34—Frame Pressing Plate
35—Spherical Protrusion
36—Curved Protrusion
37—Semi-Circular Pull Hook
38—Grounding Pin
39—PV Panel Frame

These labels correspond to the hidden end clamp for PV panel installation, ensuring clarity and precision in the documentation of the present utility model.

### DETAILED DESCRIPTION OF THE EMBODIMENT

The following section, in conjunction with the accompanying drawings, provides a clear and complete description of the technical solutions of the embodiments of the present utility model. It is evident that the described embodiments represent only a portion of the possible implementations and not all possible embodiments. Based on the disclosed embodiments, any other implementations obtained by those skilled in the field without making creative efforts fall within the scope of the present utility model.

### Structure of the Hidden End Clamp

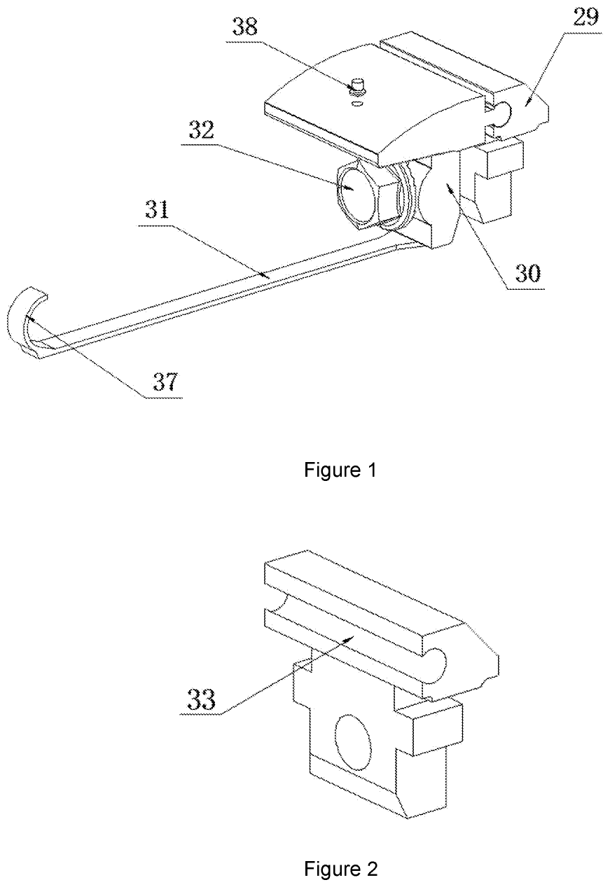

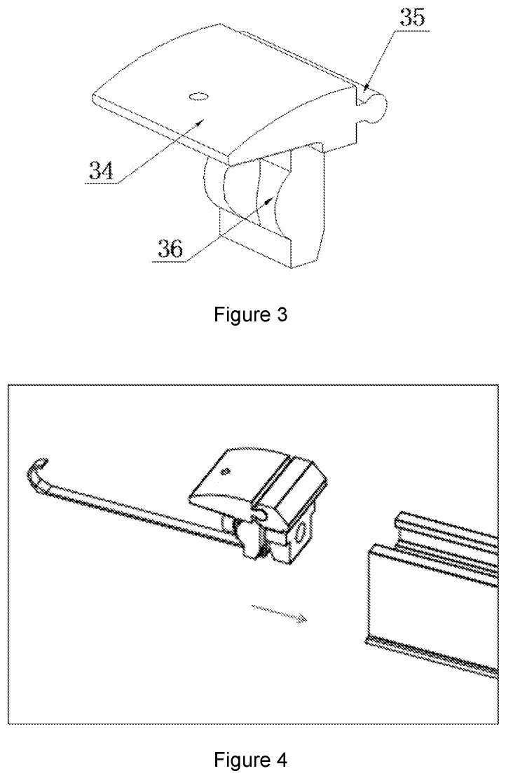

As shown in FIGS. 1 to 3, a hidden end clamp for PV panel installation is disclosed, comprising:
A fixed section (29)
A movable section (30)
A tension wire (31)

### Key Structural Features:

1. Fixed Section:
   The fixed section (29) consists of an upper spherical connection slot (33) and a lower rail connection section, allowing for secure attachment within the mounting rail.
2. Movable Section:
   The movable section (30) consists of:
      A frame pressing plate (34).
      A spherical protrusion (35), which matches the spherical connection slot (33) to allow for movable engagement, forming a bearing-like structure.
      The fixed section (29) and the movable section (30) are secured using a bolt (32).
      The movable section (30) includes a curved protrusion (36) at the bolt connection point, providing guidance when tightening the bolt.
3. Tension Wire Mechanism:
   The tension wire (31) is attached to a pull ring, which is looped around the bolt (32) for secure attachment.
   Pulling the tension wire (31) allows the frame pressing plate (34) to move vertically, facilitating panel installation.
   The tension wire (31) is made of soft plastic, with an ergonomically designed semi-circular pull hook (37) at the end, ensuring easy handling and installation.
4. Integrated Grounding Mechanism:
   The frame pressing plate (34) is equipped with a grounding pin (38) to ensure electrical continuity with the PV panel frame (39).

### Installation Process

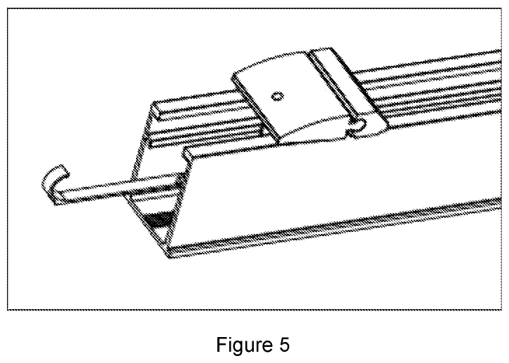

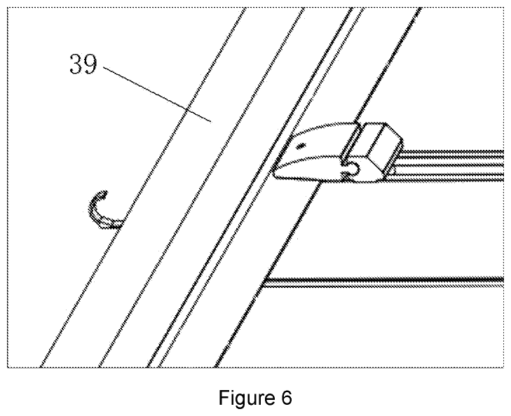

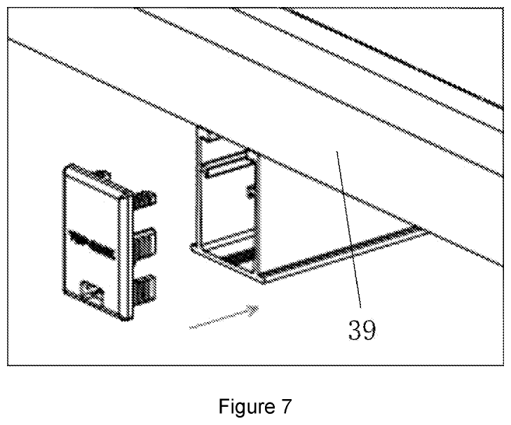

1. Preparing the Hidden End Clamp:
   At this stage, the bolt (32) is not yet tightened, allowing for vertical movement of the frame pressing plate (34).
2. Inserting the Hidden End Clamp into the Rail:
   The rail connection section of the end clamp is inserted into the mounting rail, as shown in FIG. 4.
   Once inserted, the structure is positioned as shown in FIG. 5.
3. Securing the PV Panel:
   The PV panel frame (39) is positioned in place.
   The tension wire (31) is pulled, causing the frame pressing plate (34) to press against the PV panel frame (39).
   The bolt (32) is tightened, completing the installation (FIG. 6).
   At this point, the grounding pin (38) establishes electrical continuity with the PV panel frame (39).
4. Final Positioning and Concealment:
   Once the hidden end clamp is secured, the tension wire (31) is also placed inside the rail.
   A rail end cover is installed (FIG. 7), fully concealing the end clamp, ensuring a clean and aesthetically pleasing appearance.

### Advantages of the Hidden End Clamp System

Fast and easy installation using fixed, movable, and tension wire components.
Simple structure, reducing assembly time and complexity.
Concealed within the rail, ensuring a clean and seamless look.
Curved protrusion (36) ensures accurate bolt alignment during installation.
Soft plastic tension wire can be fully hidden within the rail after installation, maintaining a neat and organized appearance.
Semi-circular pull hook (37) allows for ergonomic and effortless installation.
Embedded grounding pin (38) ensures secure electrical conductivity between the PV panel and the mounting structure.

This hidden end clamp system is an innovative and practical solution for modern PV panel installations, combining ease of installation, strong structural stability, and an aesthetically appealing hidden design.

It will be appreciated by persons skilled in the art that the present invention is not limited to what has been particularly shown and described. Rather, the scope of the present invention is defined by the claims which follow. It should further be understood that the above description is only representative of illustrative examples of embodiments. The description has not attempted to exhaustively enumerate all possible variations. The alternate embodiments may not have been presented for a specific portion of the invention, and may result from a different combination of described portions, or that other un-described alternate embodiments may be available for a portion, is not to be considered a disclaimer of those alternate embodiments. It will be appreciated that many of those un-described embodiments are within the literal scope of the following claims, and others are equivalent.

1. A clamp for PV panel installation, characterized in that it comprises a fixed section (29), a movable section (30), and a tension wire (31), wherein:
the fixed section (29) includes an upper spherical connection slot (33) and a lower rail connection section;
the movable section (30) comprises a frame pressing plate (34) and a spherical protrusion (35), which is movably connected to the spherical connection slot (33);
the fixed section (29) and the movable section (30) are connected via a bolt (32);
the tension wire (31) is attached to a pull ring, which is looped around the bolt (32) to secure its connection.

2. The clamp for PV panel installation according to claim 1, characterized in that the movable section (30) includes a curved protrusion (36) at the bolt connection point, serving as a guide during bolt tightening.

3. The clamp for PV panel installation according to claim 1, characterized in that the tension wire (31) is made of flexible plastic, with a semi-circular pull hook (37) at the end.

4. The clamp for PV panel installation according to claim 1, characterized in that the frame pressing plate (34) is additionally equipped with a grounding pin (38) to ensure electrical conductivity.
